(19) United States
(12) Patent Application Publication
(10) Pub. No.: US 2021/0350364 A1
(43) Pub. Date: Nov. 11, 2021

(54) Secure method for transmitting data between a payment terminal and a wireless printer.

(71) Applicant: Banks and Acquirers International Holding, Paris (FR)

(72) Inventors: Jean-Christophe Pommaret, PONT DE L'ISÈRE (FR); Dominique Testu, SAINT-PERAY (FR)

(21) Appl. No.: 17/263,722

(22) PCT Filed: Jul. 25, 2019
(86) PCT No.: PCT/EP2019/070084

§ 371 Date: Jan. 27, 2021

(30) Foreign Application Priority Data
Jul. 30, 2018 (FR) 1857092

(51) Int. Cl. G06Q 20/38; H04L 9/14; H04L 9/30; G06Q 20/20; G06Q 20/32; G06Q 20/40; G06F 3/12

(52) U.S. Cl. CPC G06Q 20/3829; H04L 9/14; H04L 9/3073; G06Q 20/209; G06F 3/1292; G06Q 20/401; G06F 3/1209; G06F 3/1236; G06Q 2220/00; G06Q 20/3278

(57) ABSTRACT

Novel payment terminals can take the form of a touchpad screen that incorporates no printer. This makes it possible to pool a printer among several payment terminals. The editing of a receipt confirms to confirm the invoiced amount and justify it. The data indicated in a receipt are sensitive and they must be secured before they are transmitted to the printer. However, the techniques used to encrypt the data transmitted to the printer can suffer from a security defect. A payment terminal and data-reception device are provided, which exchange messages on negotiation of a shared cryptographic key through a first near-field connection. The data relating to a transaction made by the payment terminal are then encrypted by using the shared cryptographic key and transmitted to the data-reception device through a second radio connection.

### FIELD OF THE INVENTION

The field of the invention is that of the secure data transmission between a payment terminal and a data-reception device, such as a printer.

### Prior Art and its Drawbacks

Payment terminals are now predominantly used in shops and businesses to pay for purchases. Merchants prefer these payment terminals because they offer a degree of transaction security higher than other means of payment, such as checks, and because they avert the drawbacks associated with having excessive quantities of cash. Thus, the payment terminal has become the merchant's preferred accessory.

A new generation of modular and function-rich payment terminals has appeared.

Such payment terminals, known as smart terminals, can take the form of a touchpad tablet accepting all means of payment and offering the business and trade services necessary for the management of a business. With such a tablet embedding an operating system, such as the Android operating system for example, it is possible to integrate business applications, such as invoicing applications easily and speedily in such smart payment terminals, and thus improve the merchants' experience.

Communications between a merchant and a user are an essential element for making a purchase. The merchant must first communicate his offer, a product and a price. The user gives his assent and makes payment, for example by using his bank card. Subsequently, the merchant provides a receipt in the form of a slip that indicates the amount of the payment and the product or the service purchased. This receipt, on the one hand, makes it possible to confirm the amount actually invoiced and to justify the purchase, and on the other hand allows the merchant to give the user information on the product actually purchased.

The receipt is an information medium that can be in paper form. Payment terminals do not systematically integrate a printer. This allows the merchant to pool one or more printers between a plurality of payment terminals in order to reduce costs. The payment terminals and the pooled printer can, for example, communicate through radio connections, such as, for example, Wi-Fi connections set up in accordance with the 802.11 protocols of the IEEE (Institute of Electrical and Electronics Engineers), or again Bluetooth® or BLE® (for Bluetooth Low Energy) connections.

The data shown in a receipt is sensitive and it is important that the data is secured before it is transmitted to the printer. To this end, there are many solutions for encrypting information before it is transmitted.

However, the techniques used to encrypt the data transmitted from the payment terminal to a printer suffer from a lack of security. For example, it is theoretically possible, without the merchant's knowledge, to install a device for recording the information transmitted by the payment terminal.

The fraudster, who has taken care to record the encrypted information transmitted by the payment terminal, can then theoretically access the information contained in the receipt, such as banking information of the merchant or of the customer who made the purchase. Of course, this type of attack is possible when certain conditions are met, in particular when the fraudster is able to identify the encryption protocol implemented.

There is therefore a need to provide a method of transmission that is insensitive to the flaws set forth here above.

### SUMMARY OF THE INVENTION

The invention responds to this need by proposing a method of secure reception of data relating to a transaction made by a payment terminal, the method of reception being implemented by a data-reception device and comprising a phase for obtaining a shared cryptographic key comprising the following steps:
setting up a near-field connection between the data-reception device and the payment terminal,
generating a pair of temporary cryptographic keys comprising one private cryptographic key and one public cryptographic key,
receiving at least one message transmitted through the near-field connection comprising a temporary public cryptographic key of the payment terminal,
obtaining a shared cryptographic key from the private cryptographic key of the data-reception device and from the temporary public cryptographic key of the payment terminal,
a phase for the secure receiving of data comprising the following steps:
setting up a short-distance radio connection between the data-reception device and the payment terminal,
receiving, through the short-distance radio connection, of data relating to a transaction made by the payment terminal that are encrypted by the payment terminal using the shared cryptographic key,
decrypting data relating to a transaction carried out by the payment terminal by means of the shared cryptographic key with a view to editing these data.

Thus, during a first phase, the payment terminal and the data-reception device exchange messages relating to the obtaining of a cryptographic key shared between these two devices through a near-field connection, such as for example an NFC connection. Such a near-field connection requires that the two devices should be located close to each other, typically a few tens of centimeters, thus reducing the risks of interception of the information exchanged during the exchanges.

The data-reception device and the payment terminal, each of them separately, determine the shared cryptographic key by means of the information contained in the messages exchanged.

The data relating to a transaction carried out by the payment terminal are then encrypted by the payment terminal by means of the shared cryptographic key and transmitted to the data-reception device through a short-distance radio connection.

The transmission of data relating to a transaction made by the payment terminal through the short-distance radio connection increases the level of security of the exchanges made between the payment terminal and the data-reception device because, although the near-field connection is compromised, the short-distance radio connection is perhaps not compromised. In addition, since the short-distance radio connection has a greater range, it offers greater flexibility to the merchant who can move the payment terminal away from the data-reception device without any risk of reducing the security of the exchanges between the two devices.

The shared cryptographic key is obtained by the data-reception device from a temporary public cryptographic key of the payment terminal transmitted through the near-field connection and from a temporary private cryptographic key of the data-reception device. Thus, even in the event of interception by a malicious third party of a message sent by the payment terminal comprising the temporary public key of the payment terminal, this third party would not be able to obtain the shared cryptographic key because they would have no knowledge of the temporary private cryptographic key of the data-reception device and the intercepted cryptographic keys would no longer be valid because their period of validity would have expired.

According to one embodiment of the invention, the message transmitted through the near-field connection also comprises an address of a short-distance radio interface of the payment terminal.

According to one embodiment of the invention, the short-distance radio connection is set up in accordance with the Bluetooth low-consumption protocol.

Compared with Bluetooth, Bluetooth low consumption (Bluetooth LE) offers a through-put rate of the same order of magnitude for lower-energy consumption.

According to one embodiment of the invention, the short-distance radio connection is set up in accordance with the Wi-Fi protocol.

A Wi-Fi connection offers a greater range than Bluetooth, and this can be useful in rooms with a large surface area.

According to one embodiment of the invention, the data-reception device is a wireless printer. According to one embodiment of the invention, the method of reception further comprises a step of deletion of the shared cryptographic key when a period of validity of the shared cryptographic key expires.

Thus, the cryptographic key is renewed periodically. This limits the risks of theft of a valid cryptographic key by a malicious third party.

According to one embodiment of the invention, the method of reception further comprises a step of deletion of the shared cryptographic key when a number of uses of the shared cryptographic key to encrypt data relating to a transaction carried out by the terminal payment is reached.

According to one embodiment of the invention, the data-reception device is a wireless printer.

The invention also relates to a method of secure data transmission relating to a transaction carried out by a payment terminal, to at least one data-reception device, the method of transmission being implemented by the payment terminal and comprising:
a phase of obtaining a shared cryptographic key comprising the following steps:
setting up a near-field connection between the data-reception device and the payment terminal,
generating a pair of temporary cryptographic keys comprising a private cryptographic key and a public cryptographic key,
receiving at least one message transmitted through the near-field connection comprising a temporary public cryptographic key of the data-reception device,
obtaining a shared cryptographic key from the private cryptographic key of the payment terminal and the temporary public cryptographic key of the data-reception device,
a phase for the secure reception of data comprising the following steps
setting up a short-distance radio connection between the data-reception device and the payment terminal,
encrypting data relating to a transaction made by the payment terminal through the shared cryptographic key,
transmitting, through the short-distance radio connection, of data relating to a transaction carried out by the payment terminal, the data being encrypted by means of the shared cryptographic key.

According to one embodiment of the invention, the method of reception further comprises a step of deleting the shared cryptographic key when a period of validity of the shared cryptographic key expires.

According to one embodiment of the invention, the method of reception further comprises a step of deleting the shared cryptographic key when a number of uses of the shared cryptographic key to encrypt data relating to a transaction carried out by the terminal payment is reached.

An object of the invention is also a data-reception device suitable for securely receiving data relating to a transaction carried out by a payment terminal, the data-reception device comprising means for:
setting up a near-field connection between the data-reception device and the payment terminal,
generating a pair of temporary cryptographic keys comprising a private cryptographic key and a public cryptographic key,
receiving at least one message transmitted through the near-field connection comprising a temporary public cryptographic key of the payment terminal,
obtaining a shared cryptographic key from the private cryptographic key of the data-reception device and the temporary public cryptographic key of the payment terminal,
setting up a short-distance radio connection between the data-reception device and the payment terminal,
receiving, through the short-distance radio connection, data relating to a transaction carried out by the payment terminal, the data being encrypted by the payment terminal using the shared cryptographic key,
decrypting data relating to a transaction carried out by the payment terminal using the shared cryptographic key with a view to editing them.
An object of the invention is also a payment terminal suitable for securely sending data relating to a transaction carried out by the payment terminal to at least one data-reception device, the payment terminal comprising means for:
setting up a near-field connection between the data-reception device and the payment terminal,
generating a pair of temporary cryptographic keys comprising a private cryptographic key and a public cryptographic key,
receiving at least one message transmitted through the near-field connection comprising a temporary public cryptographic key of the data-reception device,
obtaining a shared cryptographic key from the private cryptographic key of the payment terminal and from the temporary public cryptographic key of the data-reception device,
setting up a short-distance radio connection between the data-reception device and the payment terminal,
encrypting data relating to a transaction carried out by the payment terminal using the shared cryptographic key,
transmitting, through the short-distance radio connection, data relating to a transaction carried out by the payment terminal encrypted by means of the shared cryptographic key.

The invention finally relates to computer program products comprising program code instructions for implementing the methods as described here above, when they are executed by a processor.

The invention also relates to computer-readable, recording media on which are recorded computer programs comprising program code instructions for the execution of the steps of the methods of reception and transmission according to the invention.

Such recording media can be any entity or device capable of storing the program. For example, the media can comprise a storage means, such as a ROM, for example a CD ROM or a microelectronic circuit ROM, or else a magnetic recording means, for example a USB key or a hard disk drive.

Such recording media can also be a transmissible media such as an electrical or optical signal, which can be conveyed via an electrical or optical cable, by radio or by other means, so that the computer that they contain can be executed remotely. The programs according to the invention can in particular be downloaded from a network, for example the Internet.

As an alternative, the recording media can be an integrated circuit into which the program is incorporated, the circuit being adapted to executing or to being used in the execution of the above-mentioned methods of transmission and reception.

### 4. LIST OF FIGURES

Other aims, features and advantages of the invention shall appear more clearly from the following description, given by way of simple illustrative and non-exhaustive example with reference to the figures, of which:

FIG. 1 schematically shows a system in which the invention is implemented;

FIG. 2 represents a sequence diagram of the data transmission method according to one embodiment of the invention;

FIG. 3 represents a device for receiving data according to one embodiment of the invention;

FIG. 4 represents a payment terminal according to one embodiment of the invention.

### 5. DETAILED DESCRIPTION OF EMBODIMENTS OF THE INVENTION

The present technique makes it possible to solve the problem of transmitting information to a consumer who has made a purchase when the payment terminal that is used to make a purchase does not incorporate a printer to certify, on the one hand, the physical reality of the purchase and, on the other hand, the amount paid.

This is the case, for example, when the payment terminal is integrated into a station used to collect donations through contactless payment techniques or when the payment terminal is integrated into a touchscreen tablet.

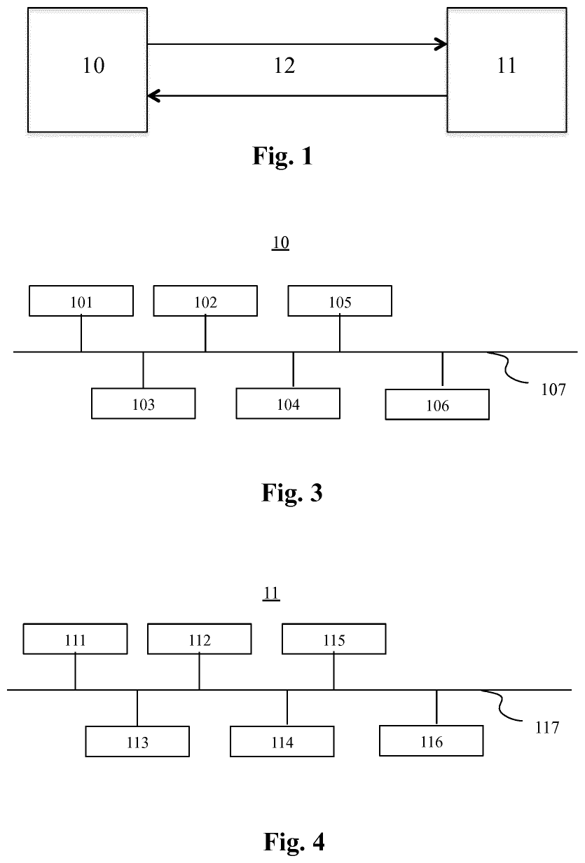

FIG. 1 schematically represents a system 1 in which the invention is implemented.

The system 1 comprises a data-reception device 10 and a payment terminal 11.

The data-reception device 10 and the payment terminal 11 exchange data to be edited by the data-reception device. This data exchange between the data-reception device 10 and the payment terminal 10 is represented by arrows 12.

The data-reception device 10 is, in one embodiment of the invention, a wireless printer allowing the printing of a receipt comprising data relating to a transaction carried out by the payment terminal 11. In another embodiment, the data-reception device 10 is provided with a screen (not shown in FIG. 1) making it possible to edit the data relating to a transaction carried out by the payment terminal 11, in particular in the form of a 2D barcode or QR-code.

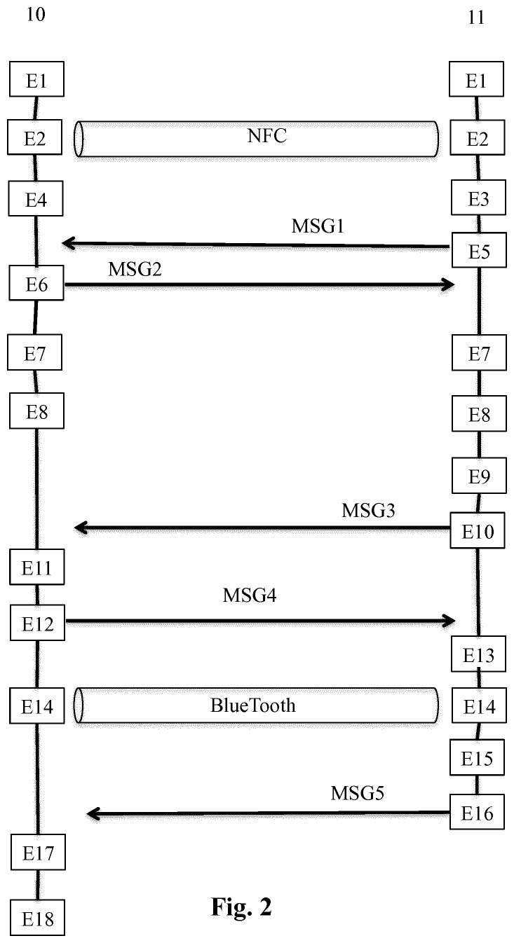

FIG. 2 represents a sequence diagram of the method of data transmission according to one embodiment of the invention.

The method of transmission for comprises two phases: a first phase of pairing the payment terminal 11 with the data-reception device 10 and a second phase of secure transmission of data relating to transactions carried out by the payment terminal 11.

The first phase, namely the pairing phase, comprises steps E1 to E12. Such a pairing phase is for example implemented every morning when the merchant powers on the payment terminal 11 and the data-reception device 10.

The second phase, namely the phase of secure transmission, comprises steps E13 to E18. Such a phase of secure transmission is implemented for each transaction made by the payment terminal 11.

At a step E1, in order to be able to edit receipts comprising data relating to transactions made such as the number of items purchased, their price, etc., the payment terminal 11 is positioned by the merchant near the device. data reception 10.

When the distance separating the payment terminal 11 and the data-reception device 10 is less than or equal to the range of transmission of an NFC chip, a near-field connection is set up between the payment terminal 11 and the data-reception device 10 during a step E2.

During a step E3, the payment terminal 11 randomly generates a pair of temporary cryptographic keys consisting of a public cryptographic key KPub11 and a private cryptographic key KPriv11. The period of validity of this pair of cryptographic keys is limited in time. Thus, when a certain period of time has elapsed, the cryptographic keys are no longer valid. In one embodiment, once the period of validity has elapsed, the cryptographic keys are deleted.

During a step E4, the data-reception device 10 randomly generates a pair of cryptographic keys consisting of a public cryptographic key KPub10 and a private cryptographic key KPriv10. The period of validity of this pair of cryptographic keys is limited in time. Thus, when a certain period of time has elapsed, the cryptographic keys are no longer valid. In one embodiment, once the period of validity has elapsed, the cryptographic keys are deleted.

During a step E5, the payment terminal 11 sends a message MSG1 through the near-field connection to the data-reception device 10. The message MSG1 comprises in particular the temporary public cryptographic key KPub11 of the payment terminal 11. In one embodiment of the invention, the message MGS1 also comprises an identifier of the payment terminal 11, such as a serial number, and an address of a short-distance radio communication interface, such as the address of a Bluetooth low-consumption interface or the address of a Wi-Fi interface of the payment terminal 11.

During a step E6, the data-reception device 10 sends a message MSG2 through the near-field connection to the payment terminal 10. The message MSG2 comprises in particular the temporary public cryptographic key KPub10 of the data-reception device 10. In one embodiment of the invention, the message MGS2 also includes an address of a short-distance radio communication interface, such as the address of a low-power Bluetooth interface or the address of a Wi-Fi interface. of the data-reception device 10.

In one embodiment of the invention, step E5 is executed before the step E6.

In another embodiment of the invention, the steps E5 and E6 are executed concomitantly.

The steps E7 and E8 for obtaining a temporary shared cryptographic key KPart are executed by the payment terminal 11 and by the data-reception device 10. Each of these two devices determines its copy of the temporary shared cryptographic key KPart.

In one embodiment of the invention, the temporary shared key KPart is obtained in accordance with the elliptic curve Diffie-Hellman key exchange protocol. Such a protocol allows an anonymous exchange of cryptographic keys that allows two peers, each having a pair of private/public cryptographic keys, to set up a shared secret through an insecure connection.

Thus, during the step E8, the data-reception device 10 obtains, by applying elliptic curve cryptography, a master cryptographic key KMast that is a function of the temporary private cryptographic key KPriv10 of the data-reception device 10 and the temporary public cryptographic key KPub11 of the payment terminal 11.

Likewise, during the step E7, the payment terminal 11 obtains, by applying elliptic curve cryptography, a master cryptographic key KMast that is a function of the temporary private cryptographic key KPriv11 of the payment terminal 11 and of the key temporary public cryptographic KPub10 of the data-reception device 10.

At a step E8, the data-reception device 10 applies a key derivation function to the master cryptographic key KMast obtained during step E7. An example of a derivation function is a hash function. The result of the derivation of the master cryptographic key KMast is the temporary shared cryptographic key KPart.

Likewise, during the step E8, the payment terminal 11 applies the same key derivation function as the data-reception device 10 to the master cryptographic key KMast obtained during step E5. The result of deriving the master cryptographic key KMast is the temporary shared cryptographic key KPart.

In an optional embodiment of the method of transmission, during a step E9, the payment terminal 11 encrypts data by means of the shared cryptographic key KPart that it has obtained in the step E8. Such data are test data having no link with data relating to a transaction performed by the payment terminal 11.

At a step E10, the payment terminal 11 sends a message MSG3 to the data-reception device 10 through the near-field connection. The message MSG3 comprises the data encrypted during the step E9.

During a step E11, the data-reception device 10 decrypts the encrypted data included in the message MSG3 by means of the temporary shared cryptographic key KPart that it obtained during step E8.

If the data-reception device 10 fails to decrypt the encrypted data received by means of the temporary shared cryptographic key KPart that it obtained during step E8, the temporary shared cryptographic key KPart is not functional. In this case, the near-field connection between the data-reception device 10 and the payment terminal 11 is interrupted.

If the data-reception device 10 decrypts the encrypted data received by means of the temporary shared cryptographic key KPart that it obtained during step E6, the temporary shared cryptographic key KPart is functional.

In such a scenario, At a step E12, the data-reception device 10 sends, through the near-field connection and to the payment terminal, a confirmation message MSG4.

At a step E13, the payment terminal 11 performs a transaction, such as a payment transaction following the purchase of a product by a consumer.

At a step E14, a short-distance radio connection is set up between the data-reception device 10 and the payment terminal 11 by means of the data exchanged in the messages MSG1 and MSG2 exchanged during the steps E5 and E6. The setting up of the short-distance radio connection is executed at the initiative of the payment terminal 11 and is triggered by the generation of data relating to a transaction performed by the payment terminal 11.

Once the short-distance radio connection has been set up between the data-reception device 10 and the payment terminal 11, the payment terminal 11, in a step E15, encrypts the data relating to the transaction made by the payment terminal 11 by means of the temporary shared cryptographic key KPart.

At a step E16, the data relating to the transaction carried out by the payment terminal 11 that are encrypted are transmitted to the data-reception device 10 in a message MSG5 through the short-distance radio connection.

At a step E17, the data-reception device 10 decrypts, by means of the temporary shared cryptographic key KPart, the received encrypted data relating to the transaction made by the payment terminal 11.

At a step E18, the data-reception device 10 edits the data relating to the transaction made by the payment terminal 11 that were decrypted during the step E17. The edition of the data relating to the transaction made by the payment terminal 11 takes the form of the printing of a paper receipt. The temporary shared cryptographic key Kpart has limited validity in order to limit the risk of fraudulent use.

Thus, in a first embodiment of the invention, the temporary shared cryptographic key KPart has a limited period of validity, for example 12 hours or 24 hours. When the period of validity of the temporary shared cryptographic key KPart expires, the payment terminal 11 and the data-reception device 10 deletes the temporary shared cryptographic key KPart.

In a second embodiment of the invention, the temporary shared cryptographic key KPart can only be used to encrypt data relating to transactions carried out by the payment terminal 11 a certain number of times, for example about twenty times.

In this embodiment, the payment terminal 11 and the data-reception device 10 implement a counter in order to determine the number of uses of the temporary shared cryptographic key KPart. When the number of uses of the temporary shared cryptographic key KPart is reached, the payment terminal 11 and the data-reception device 10 delete the temporary shared cryptographic key KPart.

When a merchant carries out a transaction with a consumer, the latter makes a payment by means of the merchant's payment terminal 11. In order to edit the receipt representing the purchase made by the consumer, the merchant triggers the transmission of data relating to the transaction made by the payment terminal 11 to a data-reception device 10, such as a wireless printer, for example by activating a key on a keyboard or by activating an icon on a touchpad screen of the payment terminal 11. The data-reception device 10 then edits the data relating to the transaction made by the payment terminal 11 in the form of a paper receipt.

Prior to any performance of a transaction with the payment terminal 11, the merchant proceeds to pair the payment terminal 11 with the data-reception device by bringing the payment terminal 11 closer to the data-reception device 10, by example by placing it near the data-reception device 10. During this pairing, the payment terminal 11 and the data-reception device 10 set up a near-field connection through which they exchange cryptographic data. Once the pairing has been completed, data relating to a purchase made by a consumer can be transmitted by the payment terminal 11 to the data-reception device 10 through a short-distance radio connection set up with the payment terminal 11 set up for the occasion. The pairing of the payment terminal 11 with the data-reception device 10 is transparent for the merchant and only lasts a few seconds. Once the payment terminal 11 and the data-reception device 10 are paired, the merchant can at any time trigger a secure data transfer between the payment terminal 11 and the data-reception device 10.

FIG. 3 represents a data-reception device 10 according to an embodiment of the invention.

The data-reception device 10 can comprise at least a hardware processor 101, one storage unit 102, one entry or input device 103, one display device 104, one interface 105, and one network interface 106 that are connected to one another through a bus 107. Naturally, the constituent elements of the data-reception device 10 can be connected by means of a connection other than a bus.

The processor 101 controls the operations of the data-reception device 10. The storage unit 102 stores at least one program for obtaining the temporary shared cryptographic key KPart and at least one program for exchanging data with the payment terminal 11, to be executed by the processor 101, and various data, such as parameters used for computations performed by processor 101, intermediate data from computations performed by processor 101, etc. The processor 101 can be formed by any known and suitable hardware or software, or by a combination of hardware and software. For example, the processor 101 can be formed by dedicated hardware such as a processing circuit, or by a programmable processing unit such as a Central Processing Unit that executes a program stored in its memory.

The storage unit 102 may be formed by any suitable means capable of storing the program or the programs and data in a computer-readable manner. Examples of storage unit 102 include computer-readable non-transient storage media such as semiconductor memories (also called solid-state memories), and magnetic, optical, or magneto-optical recording media loaded into a read-and-write unit. The program causes processor 101 to execute a secure method of data reception method according to one embodiment of the invention.

The input or entry device 103 may be formed by a keypad, a pointing device such as a mouse for use by a user to enter commands. The display device 104 is a printing module intended to print out the data relating to the transaction made by the payment terminal 11 on a paper receipt. In one embodiment, the display device 104 can also be formed by a display module, such as for example a graphical user interface (GUI). The input or entry device 103 and the display device 104 can be formed as one integral piece in the form of a touchpad screen, for example.

The interface 105 provides an interface between the data-reception device 10 and an external device. The interface 105 can communicate with the external apparatus via a wired or wireless connection. The interface 105 allows the setting up of the near-field connection and of the short radio connection with the payment terminal 11.

A network interface 106 provides a connection between the data-reception device 10 and a piece of equipment via a communication network, such as the Internet. The network interface 106 can provide, depending on its nature, a wired or wireless connection to the network.

FIG. 4 represents a payment terminal 11 according to one embodiment of the invention.

The payment terminal 11 may include at least one hardware processor 111, one storage unit 112, one input or entry device 113, one display device 114, one interface 115, and one network interface 116, these elements being connected to one another through a bus 11. Naturally, the components of the payment terminal 11 can be connected by means of a connection other than a bus.

The processor 111 commands the operations of the payment terminal 11. The storage unit 112 stores at least one program for obtaining the temporary shared cryptographic key KPart, at least one program for exchanging data with the data-reception device 10, and at least one program relating to the execution of payment transactions, to be executed by processor 111, and various data, such as parameters used for computations made by the processor 111, intermediate data for computations made by the processor 111, etc. The processor 111 can be formed by any known and suitable hardware or software, or by a combination of hardware and software. For example, the processor 111 can be formed by dedicated hardware such as a processing circuit, or by a programmable processing unit such as a Central Processing Unit that executes a program stored in its memory.

The storage unit 112 may be formed by any suitable means capable of storing the program or programs and data in a computer readable manner. Examples of a storage unit 112 include computer-readable non-transient storage media such as solid-state memories or semiconductor memories, and magnetic, optical, or magneto-optical recording media loaded in a read-and-write unit. The program causes the processor 111 to execute a secure method of reception of data according to one embodiment of the invention.

The input or entry device 113 can be formed by a keypad, a pointing device such as a mouse for use by a user to enter commands. The display device 114 can also be formed by a display module, such as for example a graphical user interface (GUI). The input or entry device 113 and the display device 114 can be formed as one integral piece in the form of a touchpad screen, for example.

The interface 115 provides an interface between the payment terminal 11 and an external apparatus. The interface 115 can communicate with the external apparatus via a wired or wireless connection. The interface 115 enable the setting up of the near-field connection and the short radio connection with the data-reception device 10.

A network interface 116 provides a connection between the payment terminal 11 and an item of equipment via a communication network, such as the Internet. The network interface 116 may provide, depending on its nature, a wired or wireless connection to the network.

1. A method of secure reception of data relating to a transaction made by a payment terminal, the method of reception being implemented by a data-reception device and comprising:
a phase of obtaining a shared cryptographic key comprising:
setting up a near-field connection between the data-reception device and the payment terminal,
generating a pair of temporary cryptographic keys comprising one private cryptographic key and one public cryptographic key,
receiving at least one message transmitted through the near-field connection comprising a temporary public cryptographic key of the payment terminal,
obtaining a shared cryptographic key from the private cryptographic key of the data-reception device and from the temporary public cryptographic key of the payment terminal,
a phase of secure reception of data comprising:
setting up a short-distance radio connection between the data-reception device and the payment terminal,
receiving, through the short-distance radio connection, of data relating to a transaction made by the payment terminal, that are encrypted by the payment terminal using the shared cryptographic key,
decrypting the data relating to a transaction carried out by the payment terminal by means of the shared cryptographic key in order to edit these data.

2. The method of reception according to claim 1, wherein the message transmitted through the near-field connection also comprises an address of a short-distance radio interface of the payment terminal.

3. The method of reception according to claim 1, wherein the short-distance radio connection is set up in accordance with the Bluetooth low-consumption protocol.

4. The method of reception according to claim 1, wherein the short-distance radio connection is set up in accordance with the Wi-Fi protocol.

5. The method of reception according to claim 1, wherein the data-reception device is a wireless printer.

6. The method of reception according to claim 1, and further comprising deleting the shared cryptographic key when a duration of validity of the cryptographic key reaches expiry.

7. The method of reception according to claim 1, and further comprising deleting the shared cryptographic key when a number of uses of the shared cryptographic key to encrypt data relating to a transaction made by the terminal payment is reached.

8. A method of secure transmission of data relating to a transaction carried out by a payment terminal, to at least one data-reception device, the method of transmission being implemented by the payment terminal and comprising:
a phase of obtaining a shared cryptographic key comprising:
setting up a near-field connection between the data-reception device and the payment terminal,
generating a pair of temporary cryptographic keys comprising a private cryptographic key and a public cryptographic key,
receiving at least one message transmitted through the near-field connection comprising a temporary public cryptographic key of the data-reception device,
obtaining a shared cryptographic key from the private cryptographic key of the payment terminal and from the temporary public cryptographic key of the data-reception device,
a phase for secure reception of data comprising:
setting up a short-distance radio connection between the data-reception device and the payment terminal, triggered by generation of the data relative to the transaction made by the payment terminal,
encrypting the data relating to the transaction made by the payment terminal through the shared cryptographic key,
transmitting, through the short-distance radio connection, the data relating to the transaction made by the payment terminal, the data being encrypted by using of the shared cryptographic key.

9. The method of transmission according to claim 9, and further comprising deleting the shared cryptographic key when a period of validity of the shared cryptographic key expires.

10. The method of transmission according to claim 9, and further comprising deleting the shared cryptographic key when a number of uses of the shared cryptographic key to encrypt data relating to a transaction made by the terminal payment is reached.

11. Data-reception device adapted to securely receiving data relating to a transaction made by a payment terminal, the data-reception device comprising:
a processor; and
a no-transitory computer-readable medium comprising instructions stored thereon which when executed by the processor configure the data-reception device to:
set up a near-field connection between the data-reception device and the payment terminal,
generate a pair of temporary cryptographic keys comprising a private cryptographic key and a public cryptographic key,
receive at least one message transmitted through the near-field connection comprising a temporary public cryptographic key of the payment terminal,
obtain a shared cryptographic key from the private cryptographic key of the data-reception device and the temporary public cryptographic key of the payment terminal,
set up a short-distance radio connection between the data-reception device and the payment terminal, which is triggered by generation of the data relating to the transaction made by the payment terminal,
receive, through the short-distance radio connection, the data relating to a transaction made by the payment terminal, that are encrypted by the payment terminal using the shared cryptographic key,
decrypt the data relating to a transaction carried out by the payment terminal using the shared cryptographic key in order to edit these data.

12. A payment terminal adapted to securely send data relating to a transaction made by the payment terminal to at least one data-reception device, the payment terminal comprising:
a processor; and
a non-transitory computer-readable medium comprising instructions stored thereon which when executed by the processor configure the payment terminal to:
set up a near-field connection between the data-reception device and the payment terminal,
generate a pair of temporary cryptographic keys comprising a private cryptographic key and a public cryptographic key,
receive at least one message transmitted through the near-field connection comprising a temporary public cryptographic key of the data-reception device,
obtain a shared cryptographic key from the private cryptographic key of the payment terminal and from the temporary public cryptographic key of the data-reception device,
set up a short-distance radio connection between the data-reception device and the payment terminal, which is triggered by generation of the data relating to the transaction made by the payment terminal,
encrypt the data relating to a transaction made by the payment terminal using the shared cryptographic key,
transmit, through the short-distance radio connection, the data relating to the transaction made by the payment terminal encrypted by using the shared cryptographic key.

13. A non-transitory computer-readable medium comprising program code instructions stored thereon for implementing a method of secure reception of data relating to a transaction made by a payment terminal, when the instructions are executed by a processor of a data-reception device, wherein the instructions configure the data-reception device to implement:
a phase of obtaining a shared cryptographic key comprising:
setting up a near-field connection between the data-reception device and the payment terminal,
generating a pair of temporary cryptographic keys comprising one private cryptographic key and one public cryptographic key,
receiving at least one message transmitted through the near-field connection comprising a temporary public cryptographic key of the payment terminal,
obtaining a shared cryptographic key from the private cryptographic key of the data-reception device and from the temporary public cryptographic key of the payment terminal,
a phase of secure reception of data comprising:
setting up a short-distance radio connection between the data-reception device and the payment terminal,
receiving, through the short-distance radio connection, of data relating to a transaction made by the payment terminal, that are encrypted by the payment terminal using the shared cryptographic key,
decrypting the data relating to a transaction carried out by the payment terminal by means of the shared cryptographic key in order to edit these data.

14. A non-transitory computer-readable medium comprising program code instructions stored thereon for implementing a method of secure transmission of data relating to a transaction carried out by a payment terminal, to at least one data-reception device, when the instructions are executed by a processor of the payment terminal, wherein the instructions configure the payment terminal to implement:
a phase of obtaining a shared cryptographic key comprising:
setting up a near-field connection between the data-reception device and the payment terminal,
generating a pair of temporary cryptographic keys comprising a private cryptographic key and a public cryptographic key,
receiving at least one message transmitted through the near-field connection comprising a temporary public cryptographic key of the data-reception device,
obtaining a shared cryptographic key from the private cryptographic key of the payment terminal and from the temporary public cryptographic key of the data-reception device,
a phase for secure reception of data comprising:
setting up a short-distance radio connection between the data-reception device and the payment terminal, triggered by generation of the data relative to the transaction made by the payment terminal,
encrypting the data relating to the transaction made by the payment terminal through the shared cryptographic key,
transmitting, through the short-distance radio connection, the data relating to the transaction made by the payment terminal, the data being encrypted by using of the shared cryptographic key.
